(19) United States
(12) Patent Application Publication
(10) Pub. No.: US 2007/0051085 A1
(43) Pub. Date: Mar. 8, 2007

(54) Systems and methods for collecting soil and lawn debris

(75) Inventors: Ronald George Jasensky JR., Shelton, CT (US); James Carpenter Whitney, Norwalk, CT (US); Gail V. Santelle, Bridgeport, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Woodland Power Products

(21) Appl. No.: 11/210,075

(22) Filed: Aug. 23, 2005

(51) Int. Cl. A01D 43/06

(52) U.S. Cl. 56/202

(57) ABSTRACT

A system for collecting vacuumed lawn debris in a collector unit is provided. The system includes a collection bin for receipt in the collector unit and a material flap hinged to the collection bin at an opening. The material flap is normally biased in a first direction away from the opening so that the material flap remains in contact with the collector unit when the collection bin is received in the collector unit.

### BACKGROUND OF THE INVENTION

1. Field of the Invention

The present disclosure is related to systems and methods for collecting soil and lawn debris. More particularly, the present disclosure is related to a system having a collection bin and/or a folding funnel and methods of use.

2. Description of Related Art

Vacuum collection, mulching, and transportation devices for material such as soil and lawn debris such as, but not limited to, leaves, sticks, rocks, lawn trimmings, and the like (hereinafter “debris”) have been developed. In use, the devices collect the debris in a collector unit or bagger (hereinafter “collector unit”).

In many regions, the local and/or state municipalities have strict rules on pick up of organic debris. Such rules can require that organic debris be provided for collection at the curbside in biodegradable containers, such as paper lawn bags. Unfortunately, the prior art has not proven effective at transferring the debris from the collector unit into waste containers or bags, such as, but not limited to, paper lawn bags, (hereinafter referred to as a “waste container”) for collection.

Accordingly, there is a continuing desire for systems and methods of collecting soil and lawn debris for transfer into waste containers.

### BRIEF SUMMARY OF THE INVENTION

It is an object of the present disclosure to provide systems and methods of collecting soil and lawn debris for transfer into waste containers.

It is another object to provide a collection bin for receipt in a vacuum collection, mulching, and transportation device, where the collection bin has a biased material flap at one side of a material opening.

It is yet another object to provide a funnel for assisting transfer of soil and lawn debris from collection bins into waste containers.

In one embodiment, a system for collecting vacuumed lawn debris in a collector unit is provided. The system includes a collection bin for receipt in the collector unit and a material flap hinged to the collection bin at an opening. The material flap is normally biased in a first direction away from the opening so that the material flap remains in contact with the collector unit when the collection bin is received in the collector unit.

A system for collecting vacuumed lawn debris that includes a collector unit and a plurality of bins is also provided. The plurality of bins each has an opening for collection of the debris and a hinged material flap at the opening. The bins are arranged in the collector unit so that the material flap of each of the bins is adjacent a side-wall of the collector unit so that the material flap guides the debris away from the side-wall and into the bins through the opening.

A folding funnel having four sides hingedly joined to one another along adjacent edges for movement between a use position and a storage position is provided. The storage position has a substantially flat profile, while the use position defines a top opening, a bottom opening, and a flow direction therebetween. The top opening is wider than the bottom opening and the four sides are normally biased to the storage position.

A method of collecting vacuumed lawn debris in a collector unit is provided. The method includes providing a plurality of bins each having an opening and a material flap hinged the opening, the material flap being normally biased in a first direction away from the opening; holding the material flap toward the opening while inserting each of the plurality of bins in the collector unit; orienting the plurality of bins so that the material flap of each bin is adjacent to a side-wall of the collector unit; and releasing the material flap so that the material flap moves in the first direction into contact with the side-wall so that the material flap guides the debris away from the side-wall and into the plurality of bins through the opening.

The above-described and other features and advantages of the present disclosure will be appreciated and understood by those skilled in the art from the following detailed description and drawings.

### BRIEF DESCRIPTION OF THE SEVERAL VIEWS OF THE DRAWINGS

FIG. 1 is a side view of a prior art vacuum device;

FIG. 2 is a top perspective view of a collection bin according to the present disclosure in use;

FIG. 3 is an end view of FIG. 2;

FIG. 4a is a side perspective view of the collection bin of FIG. 2;

FIG. 4b is a side perspective view of the collection bin of FIG. 2 having a paper lawn bag disposed therein;

FIG. 5 is a second top perspective view of the collection bin of FIG. 2 in use;

FIG. 6 is a top view of FIG. 5;

FIG. 7 is an end view of FIG. 5;

FIG. 8 is a top perspective view of an exemplary embodiment of a folding funnel according to the present disclosure in use;

FIG. 9 is a side view of the folding funnel of FIG. 8; and

FIG. 10 is a second top perspective view of an exemplary embodiment of a folding funnel according to the present disclosure in use.

### DETAILED DESCRIPTION OF THE INVENTION

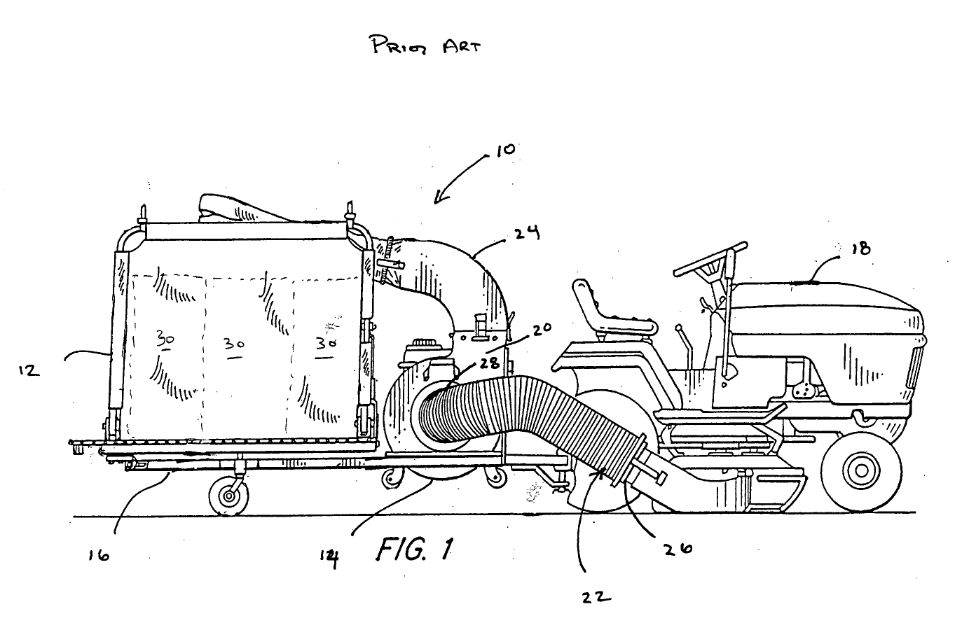

Referring to the drawings and in particular to FIG. 1, a prior art vacuum device 10 for use in the collection, mulching, and transportation of debris is shown. Vacuum device 10 can be any known device such as that as shown and described in commonly owned and assigned U.S. Pat. No. 6,029,312, the contents of which are incorporated by reference herein.

Generally, vacuum device 10 includes a debris collector unit 12 and a vacuum generator 14. Collector unit 12 and vacuum generator 14 are mounted on a chassis 16, which is securable to a typical lawn tractor 18. Vacuum generator 14 includes a power plant, such as a gas or diesel engine, for rotating an impeller (not shown) in a housing 20. The rotation of the impeller generates a vacuum in housing 20 and allows the impeller to mulch debris passing through the housing.

Vacuum device 10 includes an intake conduit 22 and an exhaust conduit 24. Intake conduit 22 has a first end 26 and a second end 28. First end 26 is releasably secured to the mower deck of tractor 18, while second end 28 is releasably secured to housing 20. In this manner, intake conduit 22 places vacuum generator 14 in fluid communication with the mower deck of tractor 18. Exhaust conduit 24 is in fluid communication with collector unit 12 so that debris drawn-in and mulched by vacuum generator 14 is collected in the collector unit.

During use, debris and trimmings collected and/or generated by tractor 18 are urged into intake conduit 22 at first end 26 by the power of the tractor's mower deck. In addition, vacuum generator 14 pulls a vacuum on the mower deck to pull the debris into vacuum device 10 for mulching and collection in collector unit 12.

Once full, debris is removed from collector unit 12. In some instances, the debris can be placed into a separate waste container for collection by local and/or state refuse services. To assist in the bagging of debris, it has also been proposed to place a number of removable open-topped bins 30 inside of collector unit 12 as shown in phantom. In this manner, bins 30 catch the debris exiting exhaust conduit 24 into collector unit 12. Once bins 30 are full, the bins can be removed from collector unit 12 and the debris transferred from the bins to the waste container for disposal.

It has been determined that the debris is not always caught by bins 30. For example, bins 30 typically fit loosely in collector unit 12 in order for the user to easily install and remove the bins from the collector unit. However, the loose fit between bins 30 and collector unit 12 allows at least a portion of the collected debris to fall between the bins, as well as between the bins and the walls of the collector unit.

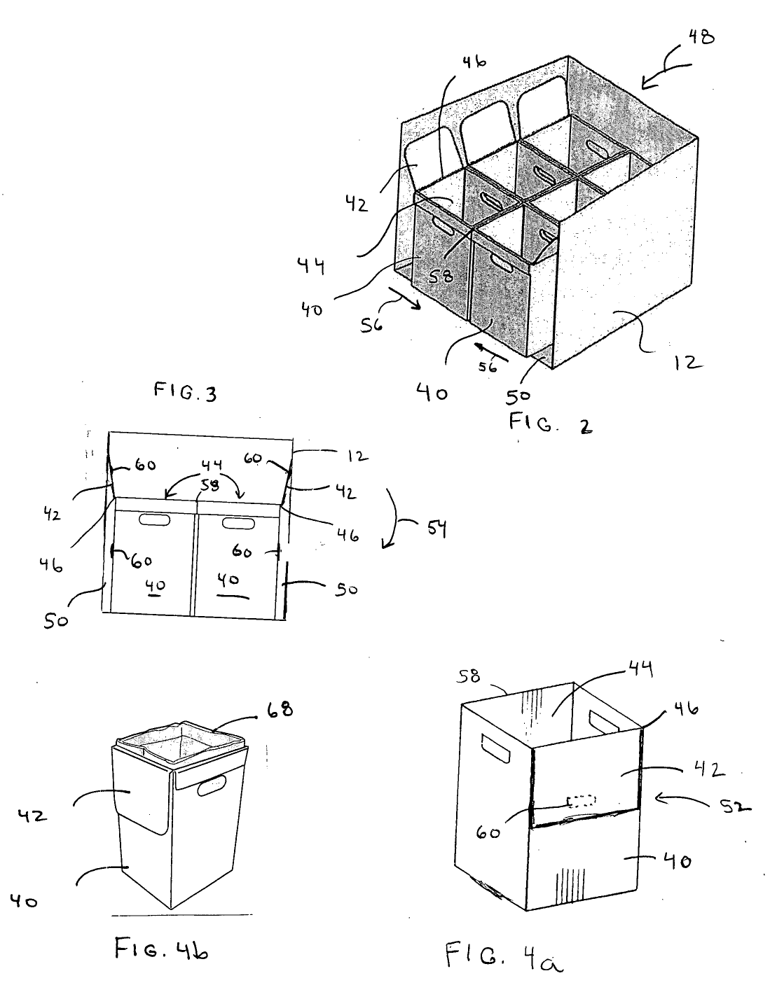

Referring now to FIGS. 2 through 4, a first exemplary embodiment of a collection bin 40 according to the present disclosure is shown in use with collector unit 12. For purposes of clarity the top and rear sections of collector unit 12 have been cut away.

Each bin 40 is preferably made from a polymer material such as, but not limited to, corrugated polypropylene or polyethylene, so that it is strong and yet also light weight, and therefore, easily removed from and installed in collector unit 12. In addition, bin 40 is collapsible so that it occupies minimal space when not in use. For example, bin 40 can be substantially as shown and described in commonly owned and assigned U.S. Pat. No. 6,029,312.

Advantageously, bin 40 includes a material flap 42 at one side of a top opening 44. Opening 44 is a generally polygonal shape sized such that a plurality of bins 40, when installed in collector unit 12, cooperate to substantially fill the collector unit. In the embodiment shown in FIGS. 2 and 3, collector unit 12 has a generally rectangular shape when viewed from above.

Material flap 42 is secured to bin 40 by a hinge 46. Preferably, material flap 42 and hinge 46 are integrally formed as part of bin 40. For example, bin 40, material flap 42, and hinge 46 can be made from one sheet of corrugated polypropylene, where the hinge 46 is defined as a living hinge between the bin and the flap.

When installed in collector unit 12, material flap 42 rests against the side-wall of the collector unit as shown in FIG. 2. Again, debris flows into collector unit 12 from exhaust conduit 24 in a flow direction 48. Material flap 42 acts as a funnel or guiding member to move the debris flowing into collector unit 12 through opening 44 of bins 40. Thus, material flap 42 ensures that debris enters bins 40 instead of into areas 50 between the bins and collector unit 12.

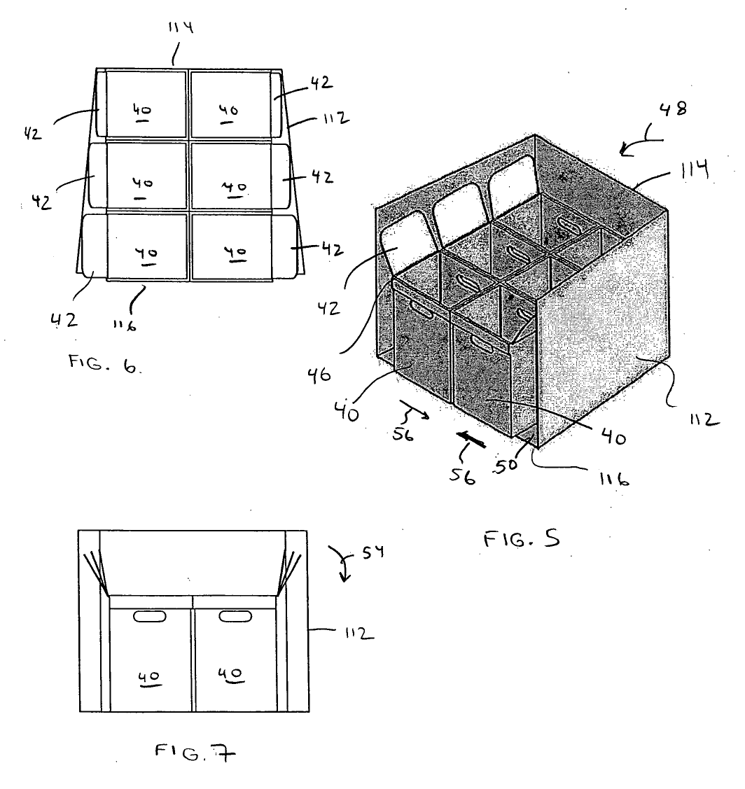

Material flap 42 is normally biased toward a folded position 52 as shown in FIG. 4a. For example, material flap 42 can be normally biased in a first direction 54 away from opening 44 by the resilient nature of the corrugated polypropylene of bin 40, flap 42, and hinge 46.

It has been determined that biasing of material flap 42 in first direction 54 further ensures that material flap 42 guides debris into bins 40. For example, the biasing of material flap 42 in first direction 54 is sufficient to maintain the material flap in contact with the side-walls of collector unit 12 even in the presence of the air flow from the exhaust conduit 24.

In addition, the biasing of material flap 42 in first direction 54 can be sufficient to urge bins 40 away from the side-walls of collector unit 12 in a second direction 56. Movement of bins 40 in second direction 56 can ensure that inside edges 58 of the bins are in contact with one another, which can mitigate the debris from falling between the bins.

In use, a user orients a bin 40 so that its material flap 42 is adjacent the side-walls of collector unit 12. Next, the user folds material flap 42 towards opening 44 and inserts bin 40 through a rear opening of collector unit 12. Once in position, the user releases material flap 42 so that the material flap moves, due to its own resiliency, in first direction 54 and into contact with the side-walls of collector unit 12. The user repeats this process until collector unit 12 has a sufficient number of bins 40 therein. In the illustrated example, six bins 40 are used. Of course, it is contemplated by the present disclosure for any desired number of bins to be used.

Once bin 40 is ready for removal, the user reverses the installation process by folding material flap 42 towards opening 44 and withdraws the bin through the rear opening of collector unit 12.

In some embodiments, the user can install a lawn bag inside of bin 40 prior to installation in collector unit 12 as shown in FIG. 4b. In this manner, collector unit 12 deposits the debris directly in the lawn bag inside of bin 40. Once bin 40 is ready for removal, the user reverses the installation process by folding material flap 42 towards opening 44 and withdraws the bin through the rear opening of collector unit 12. After removed, the lawn bag can be withdrawn from bin 40 for disposal as desired.

It has been determined that material flap 42 can make the transfer of debris from bin 40 into one or more waste container difficult. Thus, in some embodiments, material flap 42 can be secured in folded position 52 by a set of cooperating connecting devices 60. Connecting devices 60 can include, for example, male and female portions of hook-and-loop type connector, commercially available under the tradename VELCRO.

It should be recognized that bin 40 is described herein by way of example having material flap 42 on only one side. Of course, it is contemplated by the present disclosure for bin 40 to have any desired number of material flaps. Here, those flaps not in use can be secured in folded position by connecting devices 60.

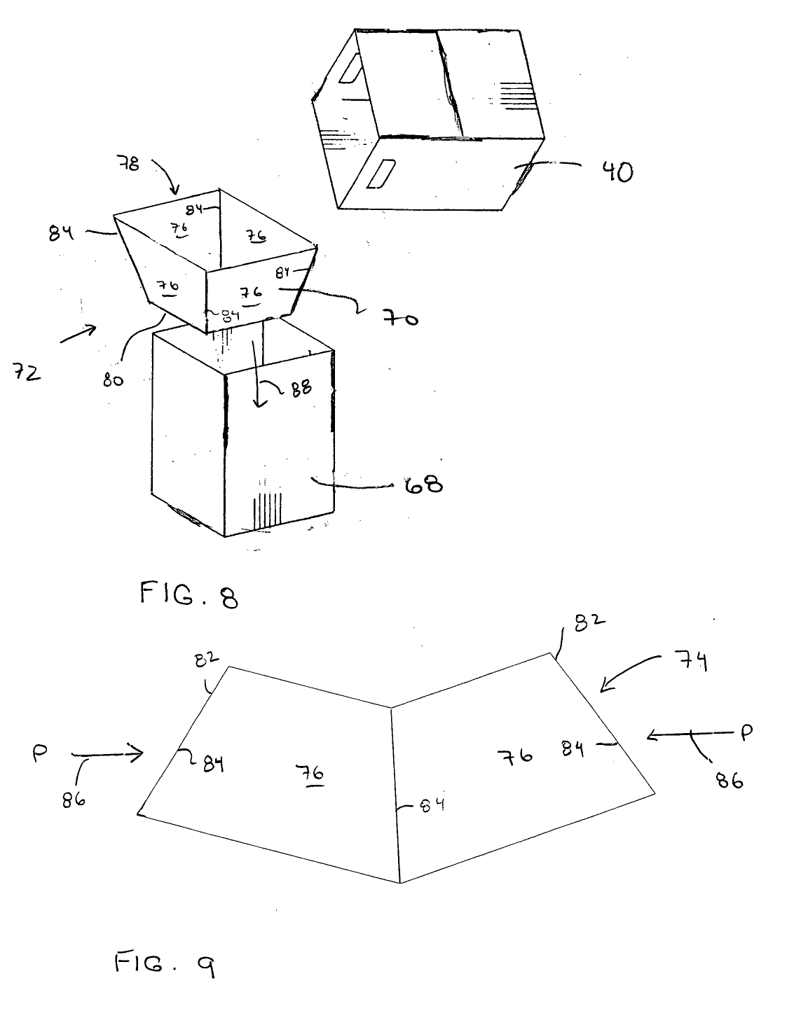

Referring now to FIGS. 5 through 7, bin 40 is shown in use with a tapered collector unit 112. Tapered collector unit 112 includes side-walls are having an increasing taper from a front end 114, which is proximate exhaust conduit 22, to a rear end 116. Thus, collector unit 112 has a generally isosceles trapezoidal shape as shown in FIG. 6, which assists a user in emptying debris and/or bins 40 from the collector unit through rear end 116.

Since bin 40 has material flaps 42 that are biased in first direction 54, the material flap advantageously maintains contact with the side-walls of tapered collector unit 112. Due to the tapering of the side-walls of collector unit 112, material flaps 42 have varying angles with respect to bin 40 when installed in the tapered collector unit as shown in FIG. 7.

The biasing of material flap 42 in first direction 54 maintains the material flap in contact with the side-walls of tapered collector unit 112 even in the presence of the air flow from the exhaust conduit 24 and can be sufficient to urge bins 40 away from the side-walls of the tapered collector unit in second direction 56. Thus, biasing of material flap 42 can ensure that debris enters bins 40 instead of into areas 50 between the bins and tapered collector unit 112 and can mitigate the debris from falling between the bins.

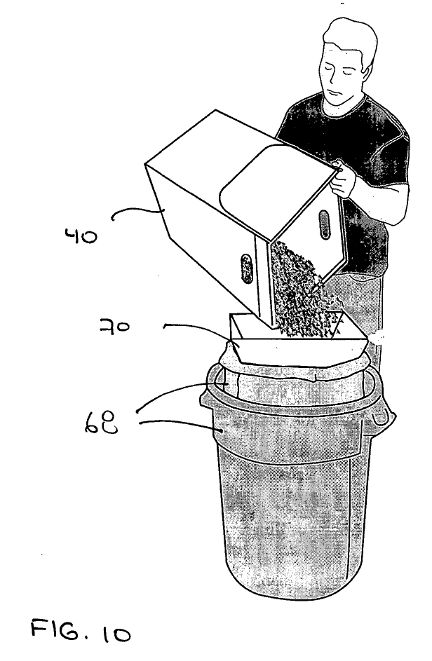

After bin 40 is filled and removed from collector unit 12 or 112, the debris within the bin can be transferred to a waste container 68, such as any commercially available paper or plastic lawn bags. Referring now to FIGS. 8 and 9, an exemplary embodiment of folding funnel 70 according to the present disclosure is shown.

Folding funnel 70 has four sides 76 that are preferably made of corrugated polypropylene so that the funnel is strong and yet also light weight. In addition, funnel 70 includes hinges 84 joining sides 76 to one another along adjacent edges 82. Preferably, sides 76 and hinges 84 are integrally formed as part of funnel 70. For example, sides 76 and hinges 84 can be made from one sheet of corrugated polypropylene joined so that at the hinges to define a living hinge between the sides. Preferably, sides 76 and hinges 84 can be made from two sheets of corrugated polymer that are mirror images of one another.

Funnel 70, having hinges 84, is collapsible so that it occupies minimal space when not in use. For example, funnel 70 can be moved between a first or use position 72 (FIG. 8) and a second or storage position 74 (FIG. 9). Funnel 70 is normally biased, by the resilient nature of the corrugated polypropylene, towards second position 74.

In first position 72, funnel 70 defines a top opening 78 and a bottom opening 80 defining a flow direction 88 therebetween. Top opening 78 is wider than bottom opening 80 and, thus, the funnel has a generally tapered funnel-like shape when in first position 72. In second position, funnel 70 has a substantially flat profile for easy storage.

In use, funnel 70 is moved to first position 72 by applying a pressure “P” in a third direction 86 to opposing side edges 82. Funnel 70 is then placed into container 68 so that bottom opening 80 is in the container. After placing bottom opening 80 in container 68, pressure P is released from funnel 70 and the funnel is maintained in first position 72 by an interaction of the funnel with the container. Next, debris from bin 40 can be emptied into container 68 by pouring the debris from the bin through top opening 78. The debris flows through funnel 70 in flow direction 88, out of bottom opening 80, and into container 68.

Advantageously, tapered funnel 70 folds between first and second positions 72, 74. Funnel 70 folds by applying pressure in third direction 86, which is perpendicular to flow direction 88. All four sides 76 are secured to one another and include hinges 84 therebetween, where the hinges are generally parallel to flow direction 88. Thus, hinges 84 have an axis of rotation that is generally parallel to flow direction 88, while funnel 70 folds between first and second positions 72, 74 a direction that is generally perpendicular to the flow direction.

It should be recognized that folding funnel 70 is described by way of example in use with bin 40 and container 68 and in the transfer of debris. Of course, it is contemplated by the present disclosure for folding funnel 70 to find use with other containers and other flowing materials. Particularly, funnel 70 is illustrated in FIG. 8 in use with container 68 having polygonal (e.g., square) cross section. Of course, it is contemplated by the present disclosure for folding funnel 70 to find use with container 68 having a circular cross section as illustrated in FIG. 10.

It should also be noted that the terms “first,” “second,” “third,” “upper,” “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the present disclosure.

1. A system for collecting vacuumed lawn debris in a collector unit, comprising:
a collection bin for receipt in the collector unit, said collection bin having an opening; and
a material flap hinged to said collection bin at said opening, wherein said material flap is normally biased in a first direction away from said opening so that said material flap remains in contact with the collector unit when said collection bin is received in the collector unit.

2. The system of claim 1, wherein said collection bin and said material flap are made from corrugated polymer.

3. The system of claim 2, wherein said material flap is normally biased in said first direction by a resilient nature of said corrugated polymer.

4. The system of claim 1, wherein said material flap is hinged to said collection bin by a living hinge.

5. The system of claim 4, wherein said material flap and said living hinge are integrally formed as part of said collection bin.

6. The system of claim 1, further comprising a set of cooperating connecting devices for securing said material flap in a folded position against said collection bin.

7. A system for collecting vacuumed lawn debris, comprising:
a collector unit for collection of the debris; and
a plurality of bins each having an opening for collection of the debris and a hinged material flap at said opening, said plurality of collection bins being arranged in said collector unit with said material flap adjacent a side-wall of said collector unit so that said material flap guides the debris away from said side-wall and into said plurality of bins through said opening.

8. The system of claim 7, wherein said material flap is normally biased in a first direction away from said opening so that said material flap of each of said plurality of bins is in contact with said side-wall.

9. The system of claim 7, wherein said collector unit has a generally rectangular or generally isosceles trapezoidal shape.

10. The system of claim 7, wherein said material flap is normally biased in a first direction away from said opening so that said plurality of bins are urged away from said side-walls in a second direction.

11. The system of claim 7, wherein said plurality of bins and said material flaps are made from corrugated polypropylene, said material flap being normally biased in a first direction away from said opening by a resilient nature of said corrugated polypropylene.

12. A folding funnel comprising four sides hingedly joined to one another along adjacent edges for movement between a use position and a storage position, said storage position having a substantially flat profile, said use position defining a top opening, a bottom opening, and a flow direction therebetween, said top opening being wider than said bottom opening, wherein said four sides are normally biased to said storage position.

13. The folding funnel of claim 12, wherein said four sides are hingedly joined to one another along adjacent edges by a living hinge that is generally parallel to said flow direction.

14. The folding funnel of claim 12, wherein said four sides move between said first and second positions a direction that is generally perpendicular to said flow direction.

15. A method of collecting vacuumed lawn debris in a collector unit, comprising:
providing a plurality of bins each having an opening and a material flap hinged at said opening, said material flap being normally biased in a first direction away from said opening;
holding said material flap toward said opening while inserting each of said plurality of bins in the collector unit;
orienting said plurality of bins so that said material flap of each bin is adjacent to a side-wall of the collector unit; and
releasing said material flap so that said material flap moves in said first direction into contact with said side-wall so that said material flap guides the debris away from said side-wall and into said plurality of bins through said opening.

16. The method of claim 15, further comprising releasing said material flap so that said material flap urges said plurality of bins away from said side-walls in a second direction so that that inside edges of said plurality of bins are in contact with one another.

17. The method of claim 15, further comprising
filling said plurality of bins with the debris; and
holding said material flap toward said opening while removing each of said plurality of bins from the collector unit.

18. The method of claim 17, further comprising:
moving a funnel from a storage position to a use position, said storage position having a substantially flat profile, said use position defining a top opening, a bottom opening, and a flow direction therebetween;
placing said bottom opening in a waste container; and
pouring the debris from a selected one of said plurality of bins into said waste container.

19. The method of claim 18, further comprising securing said material flap to said selected one before pouring the debris into said waste container.

20. The method of claim 18, further comprising:
applying pressure to said funnel, which is normally biased to said storage position, to move said funnel to said use position;
releasing said pressure after placing said bottom opening in said waste container; and
maintaining said funnel in said use position by an interaction of said funnel with said waste container.

21. The method of claim 15, further comprising inserting a waste container in each of said plurality of bins before inserting said plurality of bins in the collector unit.
